(19) United States
(12) Patent Application Publication
(10) Pub. No.: US 2003/0135837 A1
(43) Pub. Date: Jul. 17, 2003

(54) Method and apparatus for automatic arrangement and wiring for a semiconductor integrated circuit design and wiring program therefor

(76) Inventor: Hideyuki Okabe, Kanagawa (JP)

Correspondence Address: Darryl G. Walker, WALKER & SAKO, LLP, Suite 235, 300 South First Street, San Jose, CA, 95113, US

(21) Appl. No.: 10/346,801

(22) Filed: Jan. 16, 2003

(30) Foreign Application Priority Data
Jan. 17, 2002 (JP) 2002-008219

(51) Int. Cl. G06F 17/50

(52) U.S. Cl. 716/12

(57) ABSTRACT

An automatic arrangement and wiring apparatus (10) for a semiconductor integrated circuit that can remove or reduce variations in wiring areas (channels) for a top hierarchy is disclosed. An automatic arrangement and wiring apparatus (10) according to one embodiment can include a hierarchy block shape determining unit (13) for forming hierarchy blocks of essentially equal height, a row producing unit (14) for producing rows of a top hierarchy in which the hierarchy blocks can be arranged, a hierarchy block automatically arranging unit (15) for automatically arranging hierarchy blocks in the rows determined by a row producing unit (14), an external terminal position determining unit (16) for determining positions of external terminals for hierarchy blocks, a top hierarchy wiring unit (17) for distributing wiring between external terminals of a top hierarchy, a hierarchy block arrangement and wiring unit (18) for carrying out arrangement and wiring for the hierarchy blocks, and an arrangement and wiring result merging unit (20) for merging wiring results of a top hierarchy and hierarchy blocks.

### TECHNICAL FIELD

The present invention relates generally to a method an apparatus for automatic arrangement and wiring in the layout design of an integrated circuit, and an automatic arrangement and wiring program.

### BACKGROUND OF THE INVENTION

Among the various layout design methodologies for integrated circuit devices are the gate array method and the standard cell method. In such methods, logic cells (that may include AND-type gates, NOR-type gates, or more complex logic functions realized by combinations of logic circuits) can be prepared as a library. Such logic cells can be arranged in a semiconductor substrate, in an array, or the like. Alternatively, an array of logic gates can be formed in a substrate. A wiring can then be formed distributed between terminals of the cells according to a predetermined connection arrangement. In this way, a large scale integrated (LSI) semiconductor device can be manufactured.

Increasingly, the semiconductor field has sought to include more and more functions on a single integrated circuit device. This has led to “system-on-silicon” or “system-on-a-chip” designs that integrate entire system into a single integrated circuit.

Due the high complexity of systems-on-a-chip, in the case of a conventional “flat” layout method, in which an entire circuit is laid out at a time, a design turn around time (TAT) can be undesirably long. For this reason, a hierarchical layout method is adopted in many cases. In such a method, logic for a device may be divided into a number of hierarchical blocks. Circuits for such hierarchy block may then be laid out individually according to layout design methods, such as the gate array or standard cell method mentioned above. A wiring may then be distributed among the hierarchical blocks on a top hierarchy. An LSI semiconductor device composed of hierarchical blocks arranged to carry out such a layout design can be called a building block system LSI.

FIG. 10 is a flow diagram showing a building block layout apparatus for an integrated circuit according to a conventional building block method. First, data about a circuit may be entered (step 101) into a layout apparatus. In a hierarchy block producing step 152, a semiconductor integrated circuit can be divided into functional units to produce a hierarchy block for each functional unit. Because a step 152 may include dividing a semiconductor integrated circuit according to function, the sizes and/or shapes of hierarchy blocks can vary from one another. Next, in a floor plan (arrangement of hierarchy blocks) step 153, hierarchy blocks are arranged on a top hierarchy by hand (i.e., by a layout designer, or the like). Such a step may take into account a connection relationship between the hierarchy blocks. In a top hierarchy wiring step 154, a wiring is distributed between the hierarchy blocks. In addition, as represented by step 108, the arrangement and wiring for the various hierarchy blocks can be carried out concurrently with individual layout processing for hierarchical blocks.

A judging step 109 can check resulting areas and timing for a resulting layout design of the top hierarchy and hierarchy blocks. If area and timing are judged to be okay (OK), the layout results of the top hierarchy and hierarchy blocks can be merged with one another to produce a “flat” layout result. If area and timing are judged not to be okay (NG), the building block layout apparatus may return to a step 152.

In the above conventional approach, arrangement processing, which can require considerable processing time, can be executed on a smaller scale and independently for each hierarchy block. This may realize a considerable reduction in overall processing time for designing an integrated circuit.

It is noted that generally, conventional hierarchical layout methods can result in an integrated circuit that is larger in size than flat layout methods, which may be very time consuming. Such increases in size can result from differences in the shapes of hierarchy blocks. Because hierarchy blocks are differently shaped, shapes of wiring areas (channels) can be correspondingly more complicated. In addition, in a top hierarchy, hierarchy blocks can have external terminals that are at fixed positions. Thus, a top hierarchy wiring will have to deviate from a given wiring area (channel) in order to connect such fixed position terminals. Such deviations can be considered partial portion wiring areas (channels), and can increase overall wiring area for a semiconductor device. Still further, as the number of hierarchy blocks is increased, the number of wiring areas (channels) can increase correspondingly. Thus, it can be necessary to be careful to avoid overly congesting wiring areas in such cases.

Approaches to addressing undesirable increases in area that may result from a hierarchical layout design technique have been proposed. Two examples will be described below.

A first conventional example from Japanese Laid-Open Application 10-189748 A, is shown in FIG. 11. FIG. 11 is a flow diagram showing a method in which, when a circuit scale is large, wiring areas (channels) resulting from deviations in a top hierarchy wiring can be reduced. In addition, layout processing may also be reduced. First, in a data inputting step 101, data for a semiconductor integrated circuit may be input to a layout apparatus. Within a hierarchy floor plan step 162, in a “production of sub-blocks”, a file can be read out that describes a layout hierarchy information, or a designer may issue instructions interactively with a layout apparatus, to divide circuits or merge circuits to thereby construct layout hierarchies (e.g., hierarchy blocks).

Also, within a hierarchy floor plan step 162, in a “positions of sub-blocks”, a file can be read out in which positions of hierarchy blocks within a top hierarchy are described, to thereby arrange the hierarchy blocks. Further, in a “number of rows”, a file can be read out that describes a number of rows for the hierarchy blocks, or a designer can specify interactively with a layout apparatus, a desired number of rows, to thereby produce a row arrangement for hierarchy block. This can produce a row arrangement in which cells are to be arranged within the hierarchy block.

Still further within a hierarchy floor plan step 162, in a “positions of input/output (I/O) terminals”, a file can be read out in which terminal positions of hierarchy blocks are described, or a designer may specify, interactively with a layout apparatus, terminal positions, or terminal positions may be determined automatically from the relationship of connections between hierarchy blocks.

Next, in a cell arranging step 163, cells within hierarchy blocks can be arranged. In a read and develop wiring result step 164, arrangement positions for cells determined in step 163 can be arranged according to a top hierarchy (i.e., developed to a flat state).

Thereafter, in a wiring step 165 and a compaction step 166, automatic wiring and compaction can be carried out for wiring results developed for the flat state.

From the foregoing, a processing time can be largely reduced by carrying out layout steps independently for each small scale hierarchy portion of an integrated circuit. Moreover, since a high level wiring can be carried out according to flat layout approaches, wiring congestion and/or increases in wiring area (channel) due to partial portion wiring areas (channels), as described above, can be prevented.

A second conventional example from Japanese Laid-Open Application 09-199598 A, is shown in FIG. 12. FIG. 12 is a diagram showing a method in which a uniform and high density wiring for an entire semiconductor integrated circuit can be realized. In such an approach, congestion due to deviations from channel wiring areas (channels) can be reduced, and the time for a layout process can be reduced. Referring to FIG. 12, a hard macro-block 12 can be arranged on a semiconductor substrate 10. This can divide an empty area into three areas 13a, 13b and 13c. Next, rows in which cells are to be arranged can be produced for given areas 13a, 13b and 13c, and then cells may be arranged for such areas 13a, 13b and 13c.

Next, the cells arranged within the areas (13a, 13b and 13c) can include cells 232 that are connected to external terminals 231. The placement of cells can be handled as a temporary arrangement that can be subject to change. Cells other than those cells 232 that are connected to external terminals 231 can be fixed in position.

Next, wiring within areas (13a, 13b and 13c) can be carried out. However, for cells 232 a wiring pattern is not produced in this step. Next, wiring between areas (13a, 13b and 13c) can be developed to establish a top hierarchy (i.e., develop a flat state arrangement). Thereafter, those cells 232 having a temporary arrangement can be positioned according to top hierarchy connections, and then fixed in position. A top wiring can then be carried out.

From the foregoing, it can be possible to optimize a wiring arrangement for a top hierarchy using the arrangement of, and wiring information for, hierarchy blocks. This can reduce the congestion that can arise from unequal wiring in a top hierarchy. In addition, because, on a top hierarchy, wiring is made to only those cells having a temporary arrangement, the number of objects to be treated in a wiring process can be smaller. This can make the layout of an LSI semiconductor device easier.

As noted above, there is an increasing demand for higher integration leading to system-on-a-chip designs. Further, if conventional flat layout techniques, which would layout the entire circuit at a single time, are employed for such designs, enormous turn around times (TATs) can result. For this reason, conventional hierarchical layout techniques are carried out according to gate array methods or standard cell methods. Thus, a design can be divided according to a logical hierarchy into a number of hierarchical blocks. Such hierarchical blocks may be laid out individually. A wiring may then be distributed between such hierarchy blocks on a top hierarchy.

However, in conventional hierarchical layout techniques, such as that shown in FIG. 13, deviations of wiring within wiring areas (channels) (i.e., a degree of wiring congestion 182) can vary depending upon how hierarchical blocks 181 of different shape are arranged in a top hierarchy. This can lead to an increase in area needed for an integrated circuit. For this reason, in the event wiring is distributed unequally in a partial wiring areas (channel), it may be necessary to reexamine the arrangement of the hierarchical blocks (i.e., the floor plan) to arrive at a different configuration for hierarchy blocks that may relieve variations in wiring area (channel) congestion. This can contribute to overall TAT for a design.

It is noted that while current research is being made on methods for automatically arranging hierarchical blocks of various sizes, the problem presented can be similar to solving a complicated puzzle. Hence, a satisfactory solution or technique to this problem is not yet known to the inventor at this time.

For this reason, it is desirable to reduce the overall TAT in the design of semiconductor integrated circuits by preventing deviations in wiring areas (channels) congestion in the layout of a top hierarchy. However, the above mentioned conventional automatic methods of arranging and wiring in layout designs can have drawbacks, as will be described below.

First of all, in the building method of the first conventional example (FIG. 10), the deviation of wiring in particular wiring areas (channels) that arises when distributing writing between hierarchy blocks (i.e., the degree of congestion of the writing layer) can vary according to how hierarchy blocks having different shapes are arranged at the top hierarchy level. Such variations can lead to undesirable increases in integrated circuit size. In other words, the degree of congestion for wiring areas can vary according to how hierarchy blocks are positioned with respect to one another. A “bad” placement of hierarchy blocks can result in an increased deviation from wiring areas (channels) congestions and hence increase overall size in device. For this reason, a final layout result can depend upon the skill and experience of a designer in arranging hierarchy block for a top hierarchy of a device.

In addition, in conventional approaches, due to congestion of partial wiring areas (channel), it may be necessary to repeat design steps to attempt to reduce such undesirable features. For example, the production of hierarchical blocks may have to be reexamined, and the arrangement (floorplan) of hierarchy blocks may also have to be reexamined. This can result in increases in overall TAT.

Still further, if a wiring result produces a concentration of wiring in a partial wiring area (channel), wiring paths may have to be formed that route around (detour) such areas. Such added wiring to a signal path can make timing convergence of signals difficult to achieve.

In the second conventional example (JP 10-189748 A) shown in FIG. 11, hierarchy blocks, that can have varying shapes, are handled on a top hierarchy level. Thus, even if a final wiring is distributed after a flat layout of such blocks, congestion of wiring areas (channels) between blocks can occur according to the placement of hierarchy blocks prior to a final flat wiring of a top hierarchy (i.e., a “good” or “bad” placement of hierarchy blocks). This can result in an increase in area for a semiconductor device.

Thus, a final layout according to the second conventional method may also depend upon the skill and experience of a designer to arrange hierarchy blocks into a good placement rather than a bad placement. In addition, like the first conventional approach, if an initial result produces undue wiring congestion, it may be necessary to repeat the design of hierarchy blocks and/or the arrangement (floorplan) of hierarchy blocks, increasing overall TAT.

Still further, in the second conventional approach, a top hierarchy wiring arrangement is analyzed in accordance with a flat layout method. This may add considerably to TAT. Furthermore, since a final wiring is developed according to a flat layout method, for an LSI integrated circuit, such a final wiring requirement may present data on a very large scale. Such data may exceed the capabilities of the automatic wiring design tool, require an undesirably long time to process, and/or generate results in which necessary signal timing convergence does not occur.

The third conventional example (JP 09-199598 A) shown in FIG. 12, can suffer from some of the same drawbacks as the first and second conventional examples. In particular, since hierarchy blocks may have different shapes, even if a top hierarchy wiring is carried out according to a flat layout method, congestion of wiring areas (channels) between blocks can occur according that varies according to a good or bad placement of hierarchy blocks. Thus, a final layout result can depend upon the skill and experience of a designer in arranging hierarchy block for a top hierarchy of a device.

In addition, like the other above conventional approaches, if an initial result produces undue wiring congestion, it may be necessary to repeat the design of hierarchy blocks and/or the arrangement (floorplan) of hierarchy blocks, increasing overall TAT. Further, a concentration of wiring in a partial wiring area (channel) may result in detour routing that makes convergence in signal timing difficult to achieve.

In light of the above, it would be desirable to address the above mentioned drawbacks present in conventional methods of automatic arrangement and/or wiring of a semiconductor integrated circuit.

It would thus be desirable to provide a method and/or apparatus for automatic arrangement and wiring of a semiconductor integrated circuit that can generate a wiring for a top hierarchy that may reduce deviations from wiring areas that does not necessarily depend upon the skill and experience of a designer.

It would also be desirable to provide a method and/or apparatus for automatic arrangement and/or wiring of a semiconductor integrated circuit having a reduced layout processing time without necessarily reducing operating speed of an integrated circuit.

### SUMMARY OF THE INVENTION

The present invention may include an automatic arrangement and wiring method for the layout design of a semiconductor integrated circuit. The method may include dividing a semiconductor integrated circuit design into a plurality of hierarchy blocks, each having essentially the same height, forming rows for a top hierarchy of a semiconductor integrated circuit, each row having essentially the same height as the hierarchy blocks, and generating a layout design for the top hierarchy and the hierarchy blocks independently of one another.

It is understood that a hierarchy block height can be a length of a hierarchy block in a specific direction with respect to a flat shape. Similarly, a width can be a length in a direction essentially perpendicular to a height. Even more particularly, if a flat shape is rectangular, it height can correspond to a length of one side while a width can correspond to the length of side in a direction perpendicular to the height direction.

According to one aspect of the embodiments, an automatic arrangement and wiring method can also include wiring between hierarchy blocks occurring at external terminals of the hierarchy blocks, and dividing a semiconductor integrated circuit design into a plurality of hierarchy blocks can include forming hierarchy blocks with essentially the same number of external terminals.

According to another aspect of the embodiments, an automatic arrangement and wiring can include each hierarchy having a plurality of logic circuits, and dividing a semiconductor integrated circuit design into a plurality of hierarchy blocks can include forming hierarchy blocks with essentially the same number of logic circuits.

According to another aspect of the embodiments, an automatic arrangement and wiring method can include automatically arranging hierarchy blocks in rows of a top hierarchy.

According to another aspect of the embodiments, an automatic arrangement and wiring method can include wiring between hierarchy blocks occurring at external terminals of the hierarchy blocks. Further, after the hierarchy blocks are automatically arranged in the rows of the top hierarchy, positions of external terminals can be determined based on connections between hierarchy blocks.

According to another aspect of the embodiments, an automatic arrangement and wiring method can also include merging layout designs of a top hierarchy and hierarchy blocks to form a single wiring layer for a semiconductor integrated circuit.

According to another aspect of the embodiments, in an automatic arrangement and wiring method, generating a layout design for hierarchy blocks can include forming a layout design with a method selected from the group consisting of the standard cell method and the gate array method.

The present invention may also include an automatic arrangement and wiring apparatus having a hierarchy block shape determining unit for determining shapes for hierarchy blocks formed by dividing a semiconductor integrated circuit according to logical groups, the hierarchy block shapes having an essentially equal height, a hierarchy block automatically arranging unit for automatically arranging the hierarchy blocks in a plurality of rows for a top hierarchy, an external terminal positioning determining unit for determining positions of external terminals for the hierarchy blocks based on the relationship of connections between the hierarchy blocks, and a top hierarchy wiring unit for distributing a top hierarchy wiring between external terminals of the hierarchy blocks independently of the layout and wiring of the individual hierarchy blocks.

According to one aspect of the embodiments, an automatic arrangement and wiring apparatus may further include a hierarchy block producing unit for dividing net list data for a semiconductor integrated circuit to form hierarchy blocks.

According to another aspect of the embodiments, an automatic arrangement and wiring apparatus may also include a row producing unit for producing rows for a top hierarchy of a semiconductor integrated circuit.

According to another aspect of the embodiments, an automatic arrangement and wiring apparatus may further include a hierarchy block arrangement and wiring unit for carrying out arrangement and wiring for each hierarchy block.

According to another aspect of the embodiments, an automatic arrangement and wiring apparatus may further include an area and timing judging unit for judging areas and timing with respect to a top hierarchy wiring and a wiring for hierarchy blocks.

According to another aspect of the embodiments, an automatic arrangement and wiring apparatus may further include an arrangement and wiring result merging unit for merging an arrangement and wiring of the top hierarchy with that of hierarchy blocks to produce a single layout result.

The present invention may also include a computer program executable on a computing system for the layout design of a semiconductor integrated circuit. The computer program may include a hierarchy block shaping unit for modifying hierarchy block data structures, produced by dividing logic hierarchies of a semiconductor integrated circuit, to form hierarchy block layout forms of essentially equal height, a row producing unit for producing layout rows for a top hierarchy of the semiconductor integrated circuit, a hierarchy block automatically arranging unit for automatically arranging the hierarchy block layout forms in the rows, a top hierarchy wiring unit for forming top hierarchy wiring layout form between external terminals positions of the hierarchy blocks, and a hierarchy block arrangement and wiring unit for arranging and wiring structures for each hierarchy block layout form independently of the top hierarchy wiring layout form.

According to one aspect of the embodiments a computer program may also include a hierarchy block producing unit for dividing integrated circuit design data to produce a plurality of hierarchy block data structures.

According to another aspect of the embodiments a computer program may include hierarchy block structures being connected to one another by external terminals, and a hierarchy block producing unit can divide integrated circuit design data to produce hierarchy block data structures having essentially equal numbers of external terminals.

According to another aspect of the embodiments in a computer program, a hierarchy block producing unit can divide integrated circuit design data to produce hierarchy block data structures having essentially equal numbers of logic circuits.

According to another aspect of the embodiments in a computer program may also include an external terminal position determining unit for determining the external terminal positions based on connection relationships between the hierarchy blocks.

According to another aspect of the embodiments, in a computer program may also include an area and timing unit for judging areas and timing with respect to a top hierarchy having the top hierarchy wiring layout form and the hierarchy block layout forms as arranged and wired by the hierarchy block arrangement and wiring unit.

According to another aspect of the embodiments in a computer program may include an arrangement and wiring result merging unit for merging a top hierarchy wiring layout form and hierarchy block layout forms as arranged and wired by a hierarchy block arrangement and wiring unit in response to a judgment result from the area and timing unit.

The present invention can thus provide an approach that can reduce design complexity and turnaround time (TAT) for large scale integrated circuits by dividing a design into hierarchy blocks. This can reduce overall area for an integrated circuit and/or facilitate timing convergence by carrying out wiring in the limited area of a top hierarchy wiring between hierarchy blocks. It can also be possible to produce optimal wiring areas (channels) that do not vary according to a hierarchy block floor plan by producing rows into which hierarchy blocks are positioned. Thus, variations in wiring area (channel) congestion do not have to depend upon the whether an initial arrangement of hierarchy blocks of different shapes (floorplan) produces good or bad wiring results.

### BRIEF DESCRIPTION OF THE DRAWINGS

FIG. 1 is a block diagram of an automatic arrangement and wiring apparatus according to the present invention.

FIG. 2 is a flow diagram showing a hierarchy layout method according to a first embodiment.

FIG. 3A is a net list showing a configuration of a semiconductor integrated circuit.

FIG. 3B is a diagram showing an example of hierarchy blocks according to an embodiment.

FIG. 4A is a diagram showing the production of rows for a top hierarchy according to an embodiment. FIG. 4B is a diagram showing an arrangement of hierarchy blocks for a top hierarchy according to an embodiment.

FIG. 5A is a diagram showing the determination of positions of external terminals of hierarchy blocks according to an embodiment. FIG. 5B is a diagram showing the result of a top hierarchy wiring according to an embodiment.

FIG. 6A is a diagram showing an arrangement and wiring result of a hierarchy block according to an embodiment. FIG. 6B is a diagram showing a merge result for a wiring of a top hierarchy and hierarchy blocks according to an embodiment.

FIG. 7A is a diagram showing hierarchy blocks according to a second embodiment.

FIG. 7B is a diagram showing an arrangement of a hierarchy blocks for a top hierarchy according to the second embedment.

FIG. 8 is a diagram showing a top wiring result according to a second embodiment.

FIG. 9A is diagram showing an example of a third embodiment in which hierarchy blocks are formed according to a standard cell method. FIG. 9B is diagram showing an example of a fourth embodiment in which hierarchy blocks are formed according to a gate array method.

FIG. 10 is a flow chart showing a conventional building block method of layout design for a semiconductor integrated circuit.

FIG. 11 is a diagram showing the conventional approach of JP 10-189748 A.

FIG. 12 is a diagram showing the conventional approach of JP 9-199598 A.

### DETAILED DESCRIPTION OF THE EMBODIMENTS

Various embodiments of the present invention will now be described in detail with reference to a number of drawings. A preferred embodiment includes an automatic arrangement and wiring apparatus. However, it is noted that a method for automatic arrangement and wiring according to the present invention may be used in the apparatus of the present invention. Still further, the present invention may include a computer program, embodied on a computer readable medium or the like, executed by one or more computing machines as an apparatus according to the present invention. Thus various preferred embodiments of the invention will hereinafter be described together.

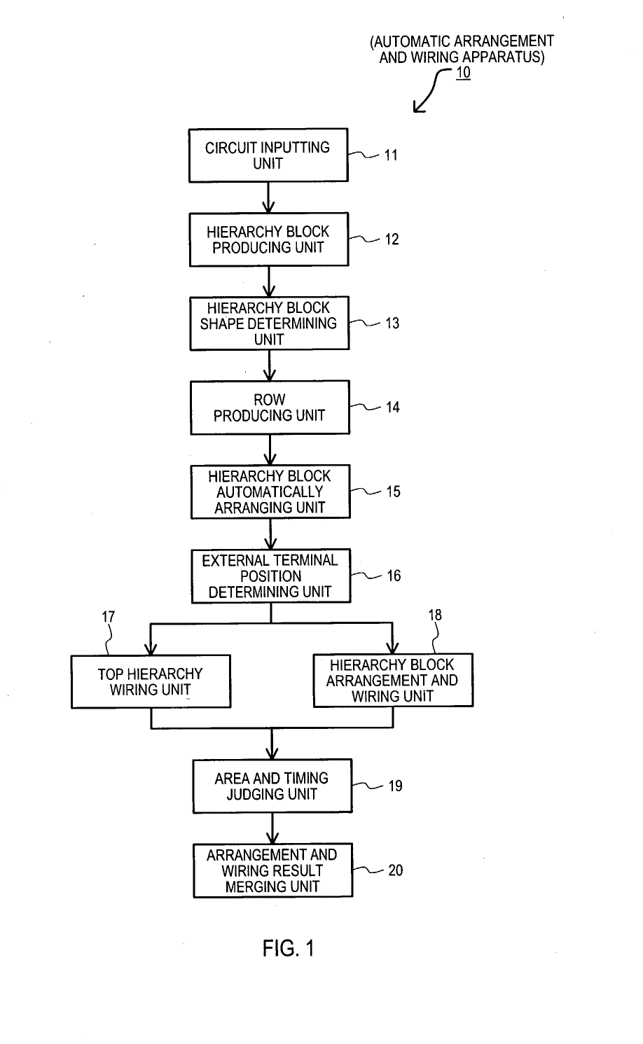

FIG. 1 is a block diagram showing a first embodiment of an automatic arrangement and wiring apparatus according to the present invention. FIG. 1 shows an automatic arrangement and writing apparatus 10 that can include a circuit inputting unit 11 for inputting data for an integrated circuit, a hierarchy block producing unit 12 for dividing integrated circuit data input to circuit inputting unit 11 to produce a number of hierarchy blocks, and a hierarchy block shape determining unit 13 for determining shapes of the hierarchy blocks produced by the hierarchy block producing unit 12.

The automatic arrangement and writing apparatus 10 may also include a row producing unit 14 for producing rows in which hierarchy blocks are arranged, where the shapes of such hierarchy blocks are determined by a hierarchy block shape determining unit 13, a hierarchy block automatically arranging unit 15 for automatically arranging hierarchy blocks in rows determined by a row producing unit 14, and an external terminal position determining unit 16 for determining positions of external terminals for hierarchy blocks based on the relationship of connections between hierarchy blocks as arranged by a hierarchy block automatically arranging unit 15.

The automatic arrangement and writing apparatus 10 may further include a top hierarchy wiring unit 17 for distributing wiring on a top hierarchy between external terminals of hierarchy blocks having positions determined by an external terminal position determining unit 16, a hierarchy block arrangement and wiring unit 18 for carrying out arrangement and wiring for hierarchy blocks having external terminal positions determined by an external terminal position determining unit 16, and an area and timing judging unit 19 for judging areas and timing with respect to a top hierarchy (for which wiring is distributed by a top hierarchy wiring unit 17) and hierarchy blocks (for which arrangement and wiring are carried out by a hierarchy block arrangement and wiring unit 18), and an arrangement and wiring result merging unit 20 for merging the arrangement and wiring results of a top hierarchy and hierarchy blocks which are determined to be successful by an area and timing judging unit 19 to thereby produce a “flat” layout result.

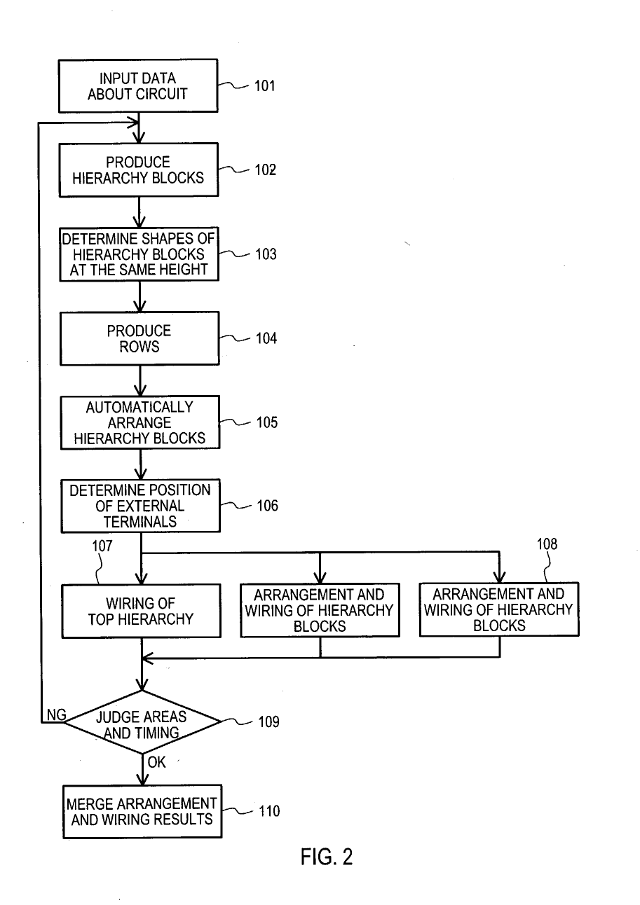

FIG. 2 is a flow chart showing the operation of an automatic arrangement and wiring apparatus shown in FIG. 1. Such an operation will be described with reference to FIGS. 1 and 2.

Referring now to FIG. 2, after data for an integrated circuit device has been input to an automatic arrangement and wiring apparatus 10 (step 101), a semiconductor integrated circuit can be divided into a plurality of hierarchy blocks such that number of external terminals of the hierarchy blocks or number of logic circuits within such hierarchy blocks can become essentially uniform (step 102). Hierarchy blocks can be determined to have an essentially same height (step 103). Next, rows in which hierarchy blocks are to be arranged can be produced for a top hierarchy (step 104). In this way, on a top hierarchy, hierarchy blocks established by dividing a semiconductor integrated circuit can be handled in a similar fashion as conventional standard cells which may be automatically arranged, as such hierarchy blocks can have essentially the same height and be placed in rows. Such an operation is shown as a step 105. FIG. 2 also includes determining positions of external terminals for such arranged hierarchy blocks (step 106).

Thereafter, a wiring for a top hierarchy can be carried out (step 107). In addition, an arrangement and wiring for hierarchy blocks can be carried out independently and concurrently to those for a top hierarchy (step 108).

It is noted that the above embodiments have described arrangements in which user logic of a semiconductor device is divided into hierarchy blocks of the same height. This is in contrast to conventional design approaches that construct hierarchy blocks according to gate array or standard cell design techniques, without regard for resulting hierarchy block shape. In such approaches, same size cells are previously prepared as items selectable from a library, or the like.

From the above descriptions, it can be understood that a large-scale semiconductor integrated circuit can be divided into a number of hierarchical blocks, and layout processing for such hierarchy blocks may be executed independently. Thus, is can be possible to layout a large-scale semiconductor integrated circuit, and also to reduce overall layout processing time. This can decrease turn around time (TAT).

In addition, by processing a wiring arrangement for hierarchy blocks independently, timing can be optimized, not for entire semiconductor device, but for the top hierarchy wiring between hierarchical blocks. Such an approach may enhance the abilities to converge on signal timing and/or reduce overall area of a semiconductor device.

Furthermore, by obtaining hierarchical blocks of a same height, hierarchical blocks can be handled in a similar fashion to normal standard cell methods. Thus, according to the present invention, hierarchy blocks can be laid out according to conventional automatic arrangement and wiring approaches. Of course, it is understood that conventional approaches are directed to arranging and wiring library based standard cell structures, and not to hierarchy blocks.

In addition, as noted above, particular embodiments can produce hierarchy blocks having an essentially uniform number of external terminals. In such cases, requirements for wiring areas (channels) for a top hierarchical layer can be easily determined. This can make estimating wiring areas (channels) easier than conventional approaches. As a result, excesses or deficiencies of wiring areas (channels) can rarely occur. In particular, it is possible to avoid wiring detours of congested areas that can occur in conventional approaches, where an arrangement of hierarchical blocks can depend on the experience and/or skill of a designer. By avoiding such wiring detours a semiconductor integrated circuit area can be reduced.

A more specific automatic arrangement and wiring apparatus 10 according to an embodiment will now be described with reference to FIG. 1. An automatic arrangement and wiring apparatus 10 can include a circuit inputting unit 11, a hierarchy block producing unit 12, for producing a number of hierarchy blocks as layout objects such that the number of external terminals of the hierarchy blocks and/or the number of logic circuits within the hierarchy blocks is essentially uniform, and a hierarchy block shape determining unit 13 for determining shapes of the hierarchy blocks so that such hierarchy blocks have heights essentially equal to one another.

The automatic arrangement and writing apparatus 10 may also include a row producing unit 14 for producing rows in which hierarchy blocks having a same essential height are arranged in a top hierarchy, a hierarchy block automatically arranging unit 15 for automatically arranging hierarchy blocks in the rows thus produced, and an external terminal position determining unit 16 for determining positions of external terminals for hierarchy blocks based on the relationship of connections between hierarchy blocks.

The automatic arrangement and writing apparatus 10 may further include a top hierarchy wiring unit 17 for distributing wiring between external terminals of hierarchy blocks on a top hierarchy, a hierarchy block arrangement and wiring unit 18 for carrying out arrangement and wiring within each hierarchy block, and an area and timing judging unit 19 for judging areas and timing with respect to the result of a wiring for a top hierarchy, and results of an arrangement and wiring of hierarchy blocks, and an arrangement and wiring result merging unit 20 for merging the arrangement of a result of a wiring for a top hierarchy, and results for the arrangement and wiring of hierarchy blocks.

The operation of the automatic arrangement and wiring apparatus 10 of the above embodiment will now be described with reference to FIGS. 1 to 6B.

Various units shown in FIG. 1 may have the following functions. A circuit inputting unit 11 can input therethrough data with respect to logic circuits of a semiconductor integrated circuit. A hierarchy block producing unit 12 can divide logic circuits of an integrated circuit device based on the relationship of connections between logic circuits of a semiconductor integrated circuit. Such a division can form a number of hierarchy block layout objects that can each have an essentially uniform number of external terminals. A hierarchy block shape determining unit 13 can determine shapes for hierarchy blocks, so that hierarchy blocks can have the same essential height.

The automatic arrangement and writing apparatus 10 may also include a row producing unit 14 that produces rows in which hierarchy blocks are arranged for a top hierarchy. Such rows may have a height that is essentially the same as those of hierarchical blocks, as determined by a hierarchy block shape determining unit 13. Such a row arrangement can produce wiring areas (channels) for which wiring for a top hierarchy can be distributed. A hierarchy block automatically arranging unit 15 can automatically arrange hierarchy blocks in rows determined by a row producing unit 14. An external terminal position determining unit 16 can determine positions of external terminals for hierarchy blocks based on the relationship of connections between hierarchy blocks. Such external terminal positions can result in wiring deviations from writing areas (channels) that can be short with respect to other conventional approaches.

The automatic arrangement and writing apparatus 10 may further include a top hierarchy wiring unit 17 that distributes wiring for a top hierarchy between external terminals of hierarchy blocks based on positions determined by an external terminal position determining unit 16, a hierarchy block arrangement and wiring unit 18 that carries out arrangement and wiring within each hierarchy block, and an area and timing judging unit 19 that judges areas and timing with respect to a top hierarchy and wiring for hierarchy blocks, and an arrangement and wiring result merging unit 20 that merges the results of a completed top hierarchy wiring and a wiring for hierarchy blocks to produce a flat layout result.

Having described embodiments of an automatic arrangement and writing apparatus and/or program 10, various examples of units that may be used in an automatic arrangement and writing apparatus and/or program 10 like that shown in FIG. 1, will now be described.

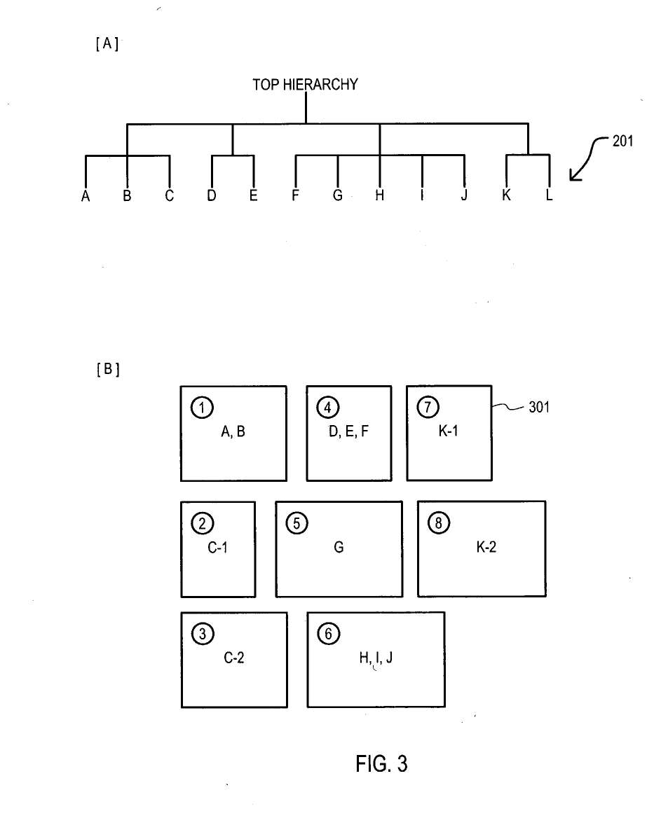

A circuit inputting unit (e.g., item 11 of FIG. 1) may input a “net” list that can represent the configuration of a semiconductor integrated circuit. One example of a net list is represented by FIG. 3A. In the example shown, a net list can include logic hierarchies A to L 201, which can present a top logic hierarchy for a semiconductor integrated circuit.

A hierarchy block producing unit 12, based on the relationship of connections between logic hierarchies, can divide logic hierarchies into hierarchy blocks, which can form layout blocks. In a particular approach, logic hierarchies represented by a net list may be arranged into hierarchy blocks based on connections between such logic hierarchies. Even more particularly, during such a division, logic circuits may be divided so that external logic terminals for hierarchy blocks can be essentially uniform. Such an arrangement can result in a top hierarchy wiring arrangement in which the number of wires in wiring areas between hierarchy blocks can be about equal to one another. Thus, wiring areas (channels) for a top hierarchy can be essentially uniform in size.

Preferably, after a number of external terminals for hierarchy blocks has been made essentially equal, a hierarchy block shape determining unit 13 can further process hierarchy block data. In particular, a hierarchy block shape determining unit 13 can take into consideration the number of logic circuits for each hierarchy block. It is noted that because hierarchy blocks can be formed based on a particular (i.e., essentially uniform) number of external terminals, once hierarchy blocks are so formed, during subsequent processing steps a number of logic circuits will essentially remain the same, and not increase or decrease.

A layout designer may easily specify a number of external terminals for hierarchy blocks. For example, combinations of logic hierarchies, like those shown as 201 in FIG. 3A, can be automatically analyzed to establish hierarchy blocks having equal numbers (or essentially equal numbers) of external terminals. Hierarchy blocks may then be produced based on such an analysis. In this way, an apparatus and method according an embodiment may establish hierarchy blocks having an essentially uniform number of external terminals.

Referring now to FIG. 3B, a diagram is set forth showing an example in which logic hierarchies of a semiconductor integrated circuit have been divided to form hierarchy blocks (one of which is shown as 301) having essentially uniform numbers of external terminals. In FIG. 3B, because the number of logic circuits within each hierarchy block 301 can be different, resulting sizes of hierarchy blocks 301 can be different. The very particular example of FIG. 3B shows eight hierarchy blocks numbered \mathring{1} through \mathring{8}, each of which may include logical hierarchies A to K shown in FIG. 3A. As is shown, a hierarchy block \mathring{1} includes logical hierarchies A and B, while hierarchy block \mathring{1} includes a portion of logical hierarchy C (shown as C-1). In this way, logical hierarchies A to K can be divided into eight hierarchy blocks \mathring{1} through \mathring{8}. The division of a large scale integrated circuit into a number of hierarchy blocks can allow a layout for hierarchy blocks to be executed independently. In this way, a layout for a large scale integrated circuit can be realized. Further, a time required to execute a layout process for such a large scale integrated circuit can be reduced over conventional approaches.

A hierarchy block shape determining unit 13 may further determine shapes for hierarchy blocks so that a height for such hierarchy blocks can be essentially equal. A height for hierarchy blocks can be specified by a layout designer on the basis of a size for an integrated circuit and/or sizes of hierarchy blocks produced by a hierarchy block producing unit 12, or the like.

Thus, once a height for hierarchy blocks has been established, widths of hierarchy blocks can be calculated. In one particular approach, widths of hierarchy blocks can be calculated by dividing a total area of logic circuits for a hierarchy block by an established height value.

FIG. 3B shows an example of hierarchy blocks having essentially uniform height according to an embodiment of the present invention. As will be described below, producing hierarchy blocks of uniform height can allow placement of hierarchy blocks to be handled in a similar fashion to normal standard cell placement techniques. Such an arrangement of essentially same height hierarchy blocks can remove variations in congestion of wiring areas (channels) that may arise in conventional approaches, in which a top hierarchy wiring depends upon the skill and experience of a designer. In this way, it can be possible to reduce overall size of a semiconductor integrated circuit.

Next, a row producing unit 14 can produce rows in which hierarchy blocks are to be arranged in a top hierarchy. Such rows can have a height essentially equal to that of hierarchy blocks, as established by hierarchy block shape determining unit 13. Still further, because hierarchy blocks can have essentially the same number of external terminals, wiring areas (channels) between rows for hierarchy blocks may also be essentially uniform. Such uniformity in hierarchy block height, row height and wiring area (channel) size can allow hierarchy blocks to be arranged in a similar fashion to a conventional standard cell method.

It is noted that if a hierarchy block producing unit 12 produces hierarchy blocks having a larger number of external terminals (still essentially the same for all hierarchy blocks), the overall number of hierarchy blocks can be smaller in proportion thereto. Thus, a number of rows and wiring areas (channels) for such hierarchy blocks can be smaller. On the other hand, if hierarchy blocks are formed having a smaller number of external terminals, the overall number of hierarchy blocks can be larger in proportion thereto. Thus, a number of rows and wiring areas (channels) for such larger number of hierarchy blocks can be larger.

Still further, it is noted that how a semiconductor integrated circuit device is divided into hierarchical blocks (e.g., according to numbers of external terminals) can affect wiring area (channel) size. That is, if hierarchy blocks have a larger number of external terminals, a wiring area can be larger, and vice versa.

From the above relationships between number of hierarchy blocks, number of rows and resulting wiring channel size, a number of hierarchy blocks can be balanced with a resulting wiring area (channel) size to form an overall layout for an integrated circuit device.

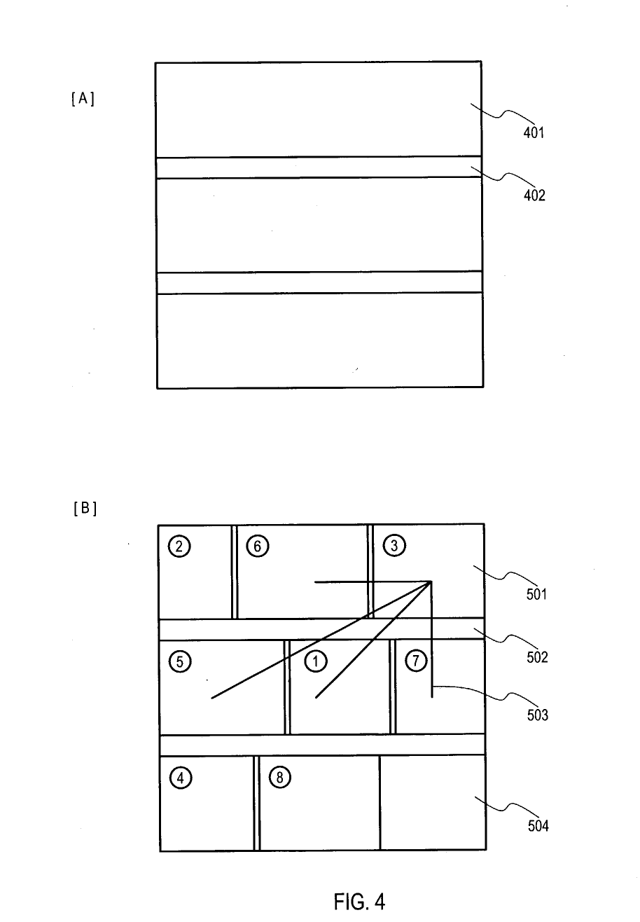

FIG. 4A shows one example of a resulting layout that may be formed according to an embodiment. FIG. 4A shows a number of rows (e.g., 401) that each have a same height as hierarchy blocks of a top hierarchy. In addition, wiring areas (channels) (e.g., 402) are formed between rows 401. Such wiring areas (channels) 402 may hold wiring to be distributed between external terminals of hierarchy blocks formed in rows 401.

Next, a hierarchy block automatically arranging unit 15 can arrange hierarchy blocks into rows produced by row producing unit 14. At this time, since rows having a same size height as hierarchy blocks are formed, hierarchy blocks may be arranged in a same general fashion as standard cell approaches. As but a few of the many possible examples, hierarchy blocks may be arranged according to a simulated annealing method, minimum cut method, or mathematic calculation method. FIG. 4B shows a result of an example in which hierarchy blocks are arranged into rows, taking into account connection strength between hierarchy blocks.

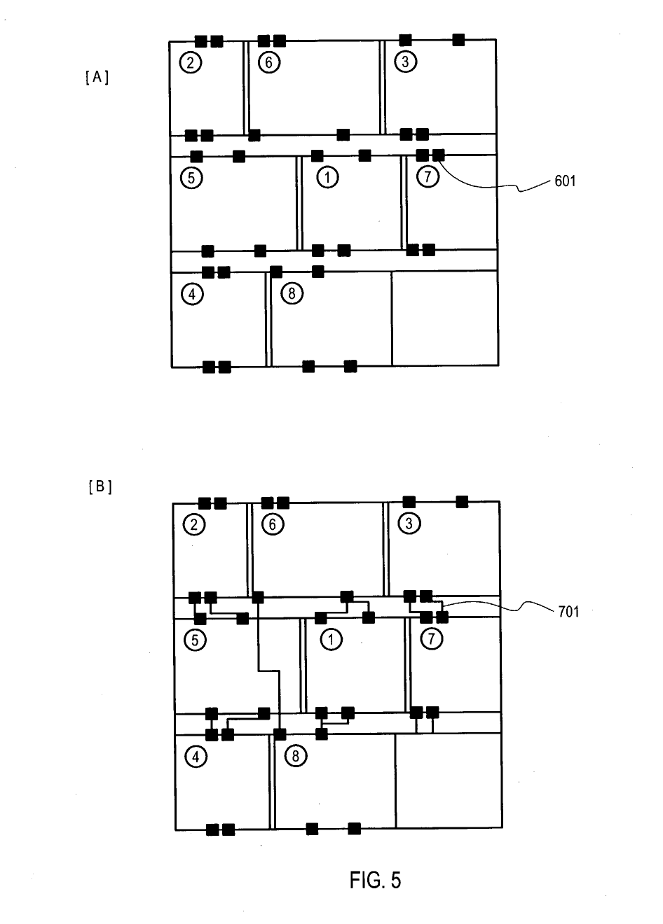

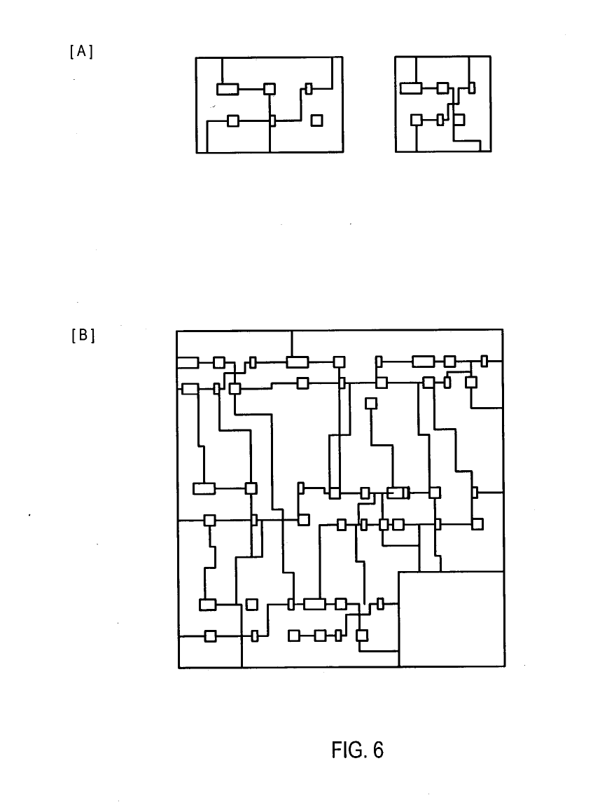

Next, an external terminal position determining unit 16 can determine positions of external terminals for hierarchy blocks. At this time, because positions of hierarchy blocks may already be established by operation of a hierarchy block automatically arranging unit 15, directions of connections between external terminals can be readily obtained. Thus, on the basis of connections between hierarchy blocks and positions of hierarchy blocks, positions of external terminals can be derived that can minimize wiring length for a top hierarchy. FIG. 5A shows one example of the determination of external terminal positions (one of which is shown as item 601), according to an embodiment of the present invention.

Subsequently, a top hierarchy wiring unit 17 can distribute wiring between external terminal positions of hierarchy blocks as established by an external terminal position determining unit 16. Such a wiring method may use conventional approaches. As but two of the possible examples, the labyrinth method or channel wiring method can be used. FIG. 5B shows the resulting top hierarchy wiring formed by a top hierarchy wiring unit 17 according to an embodiment.

Next, a hierarchy block arrangement and wiring unit 18 can carry out arranging and wiring within hierarchy blocks. It is noted that because a top hierarchy placement and wiring can be established independently of hierarchy blocks, it can be possible to process the arrangement of wiring for each hierarchy block in parallel with one another. Still further, as shown in FIGS. 1 and 2, a top hierarchy arrangement and wiring may be executed in parallel with that for individual hierarchy blocks. An arrangement and wiring method for individual hierarchy blocks can be conventional, similar to those methods used for a top hierarchy. In addition, arrangement and wiring method can produce layout results for individual hierarchy blocks, signal timing convergence can be realized for such individual hierarchy blocks.

FIG. 6A shows an example of arrangement and wiring within hierarchy blocks according to an embodiment. Thus, by carrying out arrangement and wiring for hierarchy blocks independently (e.g., separately from arrangement and wiring of hierarchy blocks), it can be possible to optimize timing, not for an entire semiconductor integrated circuit, but for a partial portion, such as that for wiring between hierarchy blocks. It may thus also be possible to enhance timing convergence for such a hierarchy block and/or reduce overall area of a hierarchy block.

Finally, assuming that an area and timing judging unit 19 does not find any problems with the area and timing of a resulting semiconductor integrated circuit design, an arrangement and wiring result merging unit 20 can merge the results of a top hierarchy layout with that of hierarchy blocks to produce flat layout result. FIG. 6B shows an example in which layout results for a top hierarchy and for hierarchy blocks are merged.

As has been described above, according to the above embodiments, by dividing a large scale integrated circuit device into a number of hierarchy blocks, and executing a layout processing for such hierarchy blocks independently, it can be possible to accomplish the layout of a large scale integrated circuit, and to reduce the time required for layout processing. In addition, it can be possible to optimize timing, not for an entire semiconductor integrated circuit, but for a partial portion such as wiring between hierarchy blocks, to enhance timing convergence for such a hierarchy block, reduce overall area of a hierarchy block, or reduce overall size occupied by hierarchy blocks. Still further, by dividing an integrated circuit and obtaining hierarchy blocks having an essentially same size height, it can be possible to arrange and wire such hierarchy blocks in a similar fashion as conventional standard cell approaches. It may also be possible to remove variations in wiring congestion of wiring areas (channels) that may result from conventional hierarchy block arranging methods, where results may depend upon the experience and skill of a designer. Thus, the present invention can reduce an area of a semiconductor device.

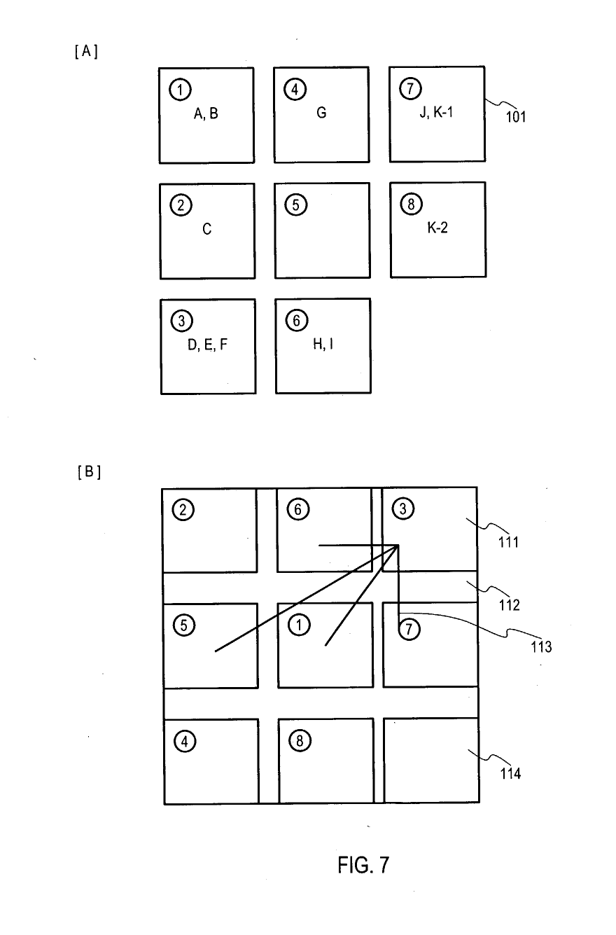

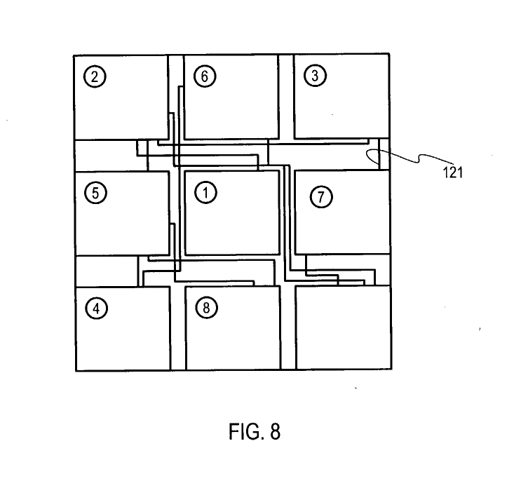

An automatic arrangement and wiring apparatus according to a second embodiment of the present invention will now be described. Various units of a second embodiment can be the same as those shown in FIG. 1, but may have different functions, as will be described below. Thus, a second embodiment will now be described with reference to FIG. 1, FIGS. 7A, 7B, and 8.

The second embodiment can differ from the above embodiment in that hierarchy blocks may be formed that have an essentially uniform number of logic circuits. This is in contrast to the above example, which formed hierarchy blocks to have an essentially uniform number of external logic circuits. Thus, according to a second embodiment, and as shown in FIG. 7A, a size of hierarchy blocks (e.g., 101) can be essentially uniform.

FIG. 7B is an example of how hierarchy blocks of essentially uniform size can be arranged in a top hierarchy according to a second embodiment. In FIG. 7B, it is noted that wiring areas (channels) in which wiring for hierarchy blocks it to be distributed can exist not only in a horizontal direction, but also a vertical direction.

FIG. 8 shows an example of how wiring can be distributed between external terminals of hierarchy blocks on a top hierarchy.

The second embodiment will now be described with more detail with reference to FIG. 1. In a similar fashion as the above embodiments, a circuit inputting unit 11 can input configuration for a integrated circuit, such as a net list, or the like.

Next, a hierarchy block producing unit 12, on the basis of a relationship of connections between logic hierarchies of an integrated circuit, can divide logic hierarchies of a net list (or the like) into a number of hierarchy blocks, which can form layout objects. It will be recalled that in the above embodiment, such a division could was based on producing hierarchy blocks having essentially equal numbers of external terminal. However, in the present embodiment, such a division logic hierarchies are divided to produce hierarchy blocks having essentially equal numbers of logic circuits. Such an approach can result in hierarchy blocks of essentially the same size. Further, it is also possible to form wiring areas (channels) for a top hierarchy that extend, not only in a horizontal direction, but also in a vertical direction.

In a hierarchy block producing unit 12, a layout designer can specify a number of logic circuits for hierarchy blocks. Thus, combinations of logic hierarchies (e.g., like that demonstrated by FIG. 3A) may be automatically examined and divided to form collections having the essentially the number of logic circuits, as designated by a layout designer. In this way, hierarchy blocks may be automatically produced.

FIG. 7A is a diagram showing a division of logic hierarchies into groups having essentially uniform numbers of logic circuits. Thus, in FIG. 7A, each hierarchy block can have the same size. Also, FIG. 7A shows eight hierarchy blocks numbered \mathring{1} through \mathring{8}, each of which may include logical hierarchies A to K shown in FIG. 3A. As is shown, a hierarchy block \mathring{1} is includes logical hierarchies A and B, while hierarchy block \mathring{1} includes logical hierarchy C. In this way, logical hierarchies A to K can be divided into eight hierarchy blocks \mathring{1} through \mathring{8}.

Next, a hierarchy block shape determining unit 13 can determine a shape for hierarchy blocks established by a hierarchy block producing unit 12, so that a height for such hierarchy blocks can be essentially equal. Because a number of logic circuits within such hierarchy blocks can be equal, hierarchy blocks having essentially the same height can have essentially the same width. Thus, hierarchy blocks according to a second embodiment can have essentially the same size. Accordingly, FIG. 7A shows hierarchy blocks of essentially the same size.

Next, a row producing unit 14 can produce rows in which hierarchy blocks having a same size are to be arranged in a top hierarchy. At this point, because hierarchy blocks can have essentially the same width, it is possible to produce wiring areas (channels) that extend in both horizontal and vertical directions. Such wiring areas (channels) may receive wiring for distribution between external terminals of hierarchy blocks.

Next, a hierarchy block automatically arranging unit 15 can arrange hierarchy blocks into rows produced by row producing unit 14. Such an arranging of hierarchy blocks may occur in the same general fashion as the embodiment described above (i.e., with conventional methods similar to standard cell methods). FIG. 7B shows an example in which hierarchy blocks (e.g., 111) are arranged in rows in a top hierarchy. FIG. 7B shows a result of an example in which hierarchy blocks are arranged into rows taking into account connection strength between hierarchy blocks, and also shows wiring areas (channels) (e.g., 112) formed in both vertical and horizontal directions.

Subsequently, an external terminal position determining unit 16 can determine positions of external terminals for hierarchy blocks.

Next, a top hierarchy wiring unit 17 can distribute wiring between external terminal positions of hierarchy blocks as established by an external terminal position determining unit 16. Such a wiring method may use conventional approaches, like those described above. FIG. 8 shows a resulting top hierarchy wiring that can be formed by a top hierarchy wiring unit 17 according to a second embodiment.

Subsequently, a hierarchy block arrangement and wiring unit 18 can carry out arranging and wiring within hierarchy blocks. It is noted that because a top hierarchy placement and wiring can be established independently of hierarchy blocks, it can be possible to process the arrangement of wiring for each hierarchy block in parallel with one another. Still further, as shown in FIGS. 1 and 2, a top hierarchy arrangement and wiring may be executed in parallel with that for individual hierarchy blocks. An arrangement and wiring method for individual hierarchy blocks can be conventional, like those described above.

Finally, assuming that an area and timing judging unit 19 does not find any problems with the area and timing of a resulting semiconductor integrated circuit design, an arrangement and wiring result merging unit 20 can merge the results of a top hierarchy layout with that of hierarchy blocks to produce flat layout result. FIG. 6B shows an example in which layout results for a top hierarchy and for hierarchy blocks are merged.

As has been described above, according to a second embodiment, by dividing a large scale integrated circuit device into a number of hierarchy blocks of essentially equal height and width, it can be possible to produce wiring areas (channels) that extend in both a vertical and horizontal direction. Such an arrangement can allow for shortening of wiring paths in a longitudinal (vertical) direction. For this reason, according to a second embodiment, wiring for hierarchy blocks can be handled in a similar fashion to standard cell methods, and thus it may also be possible to remove variations in the congestion of wiring areas (channels) that may result from conventional hierarchy block arranging methods, where results may depend upon the experience and skill of a designer.

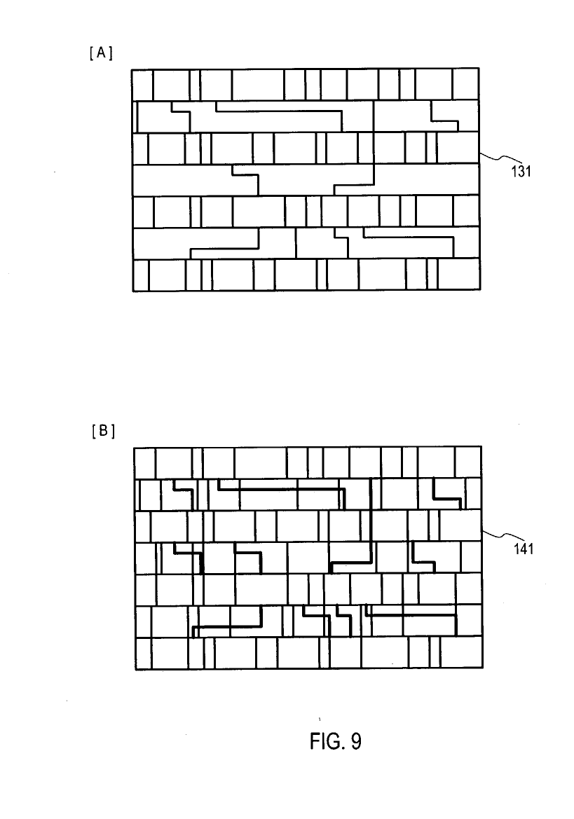

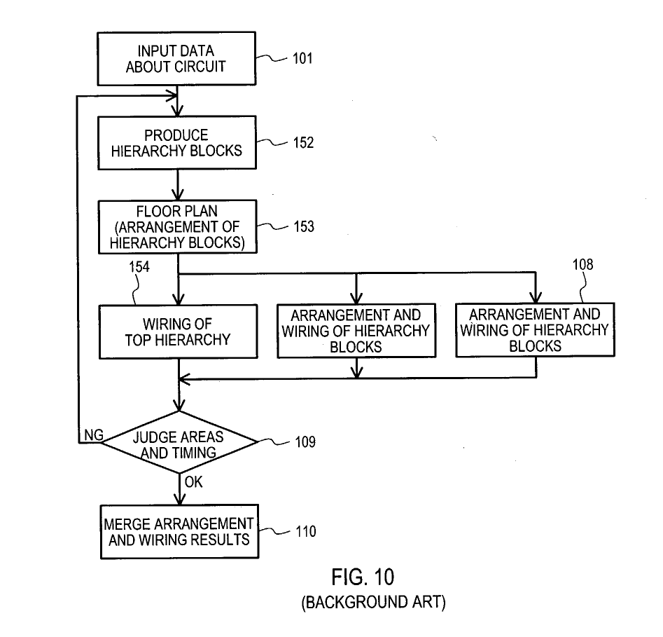

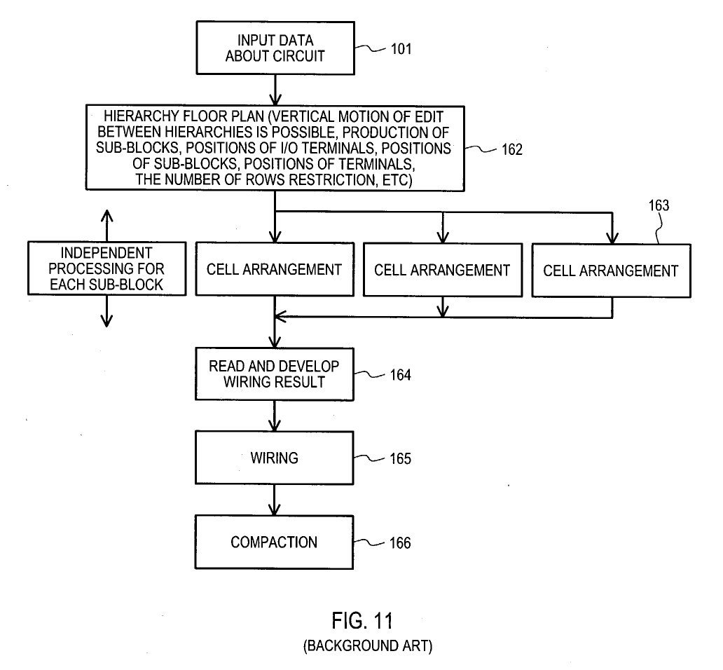

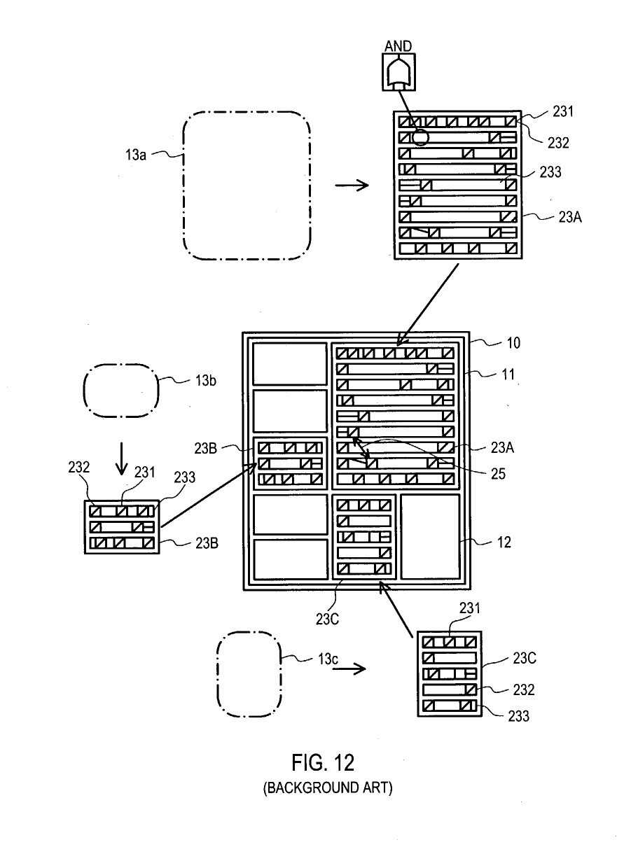

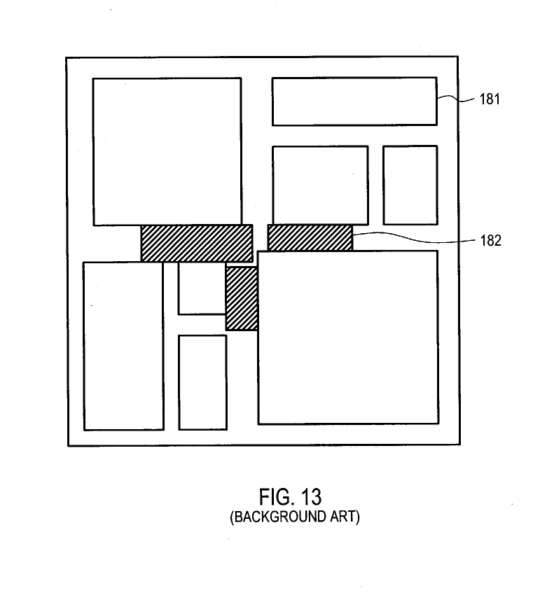

An automatic arrangement and wiring apparatus according to a third embodiment of the present invention will now be described. Various units of a second embodiment can be the same as those shown in FIG. 1, but may have different functions, as will be described below. Thus, a second embodiment will now be described with reference to FIGS. 1 and 9A. A third embodiment can apply standard cell methods to hierarchy blocks.

The third embodiment will now be described with more detail with reference to FIG. 1. In a similar fashion as the above embodiments, a circuit inputting unit 11 can input configuration for a integrated circuit, such as a net list, or the like. Next, a hierarchy block producing unit 12, on the basis of a relationship of connections between logic hierarchies, can divide logic hierarchies into a number of hierarchy blocks, which can form layout objects. Next, a hierarchy block shape determining unit 13 can determine a shape for hierarchy blocks, so that a height for such hierarchy blocks can be essentially equal.

Next, a row producing unit 14 can produce rows in which hierarchy blocks having a same sizes are to be arranged in a top hierarchy. A hierarchy block automatically arranging unit 15 can then arrange hierarchy blocks into the rows of a top hierarchy. Such an arranging of hierarchy blocks may occur in the same general fashion as the embodiment described above. Next, an external terminal position determining unit 16 can determine positions of external terminals for hierarchy blocks. A top hierarchy wiring unit 17 can then distribute wiring between external terminal positions of hierarchy blocks as established by an external terminal position determining unit 16, and such a wiring method may use conventional approaches, like those described above. FIG. 8 is one very particular example of wiring results for a top hierarchy.

Subsequently, a hierarchy block arrangement and wiring unit 18 can carry out arranging and wiring within hierarchy blocks. In a third embodiment, such arrangement and wiring can be according to conventional standard cell methods. Thus, rows and channels for logic cells within hierarchy blocks may be produced before an arrangement of the hierarchy blocks. Methods for producing such rows and channels for logic cells can be conventional standard cell methods.

FIG. 9A is an example of layout results for hierarchy blocks using standard cell methods. Because, such arrangement and wiring for hierarchical block may be carried out independently of one another, it can be possible to process the arrangement of wiring for each hierarchy block in parallel with one another. An arrangement and wiring method for individual hierarchy blocks can be conventional, like those described above.

Finally, assuming that an area and timing judging unit 19 does not find any problems with the area and timing of a resulting semiconductor integrated circuit design, an arrangement and wiring result merging unit 20 can merge the results of a top hierarchy layout with that of hierarchy blocks to produce flat layout result.

As has been described above, according to a third embodiment, even though a large scale integrated circuit device is divided into a number of hierarchy blocks, arrangement and wiring for hierarchy blocks may be carried out independently according to standard cell methods. This can make it possible to optimize timing not for a whole semiconductor integrated circuit, but in a partial portion, such as a hierarchy block. Such an approach can enhance timing convergence and/or reduce the area of a hierarchy block. Further, according to a third embodiment, wiring for hierarchy blocks can be handled in a similar fashion to standard cell methods, and thus it may also be possible to remove variations in the congestion of wiring areas (channels) that may result from conventional hierarchy block arranging methods, where results may depend upon the experience and skill of a designer.

An automatic arrangement and wiring apparatus according to a fourth embodiment of the present invention will now be described. Various units of a second embodiment can be the same as those shown in FIG. 1, but may have different functions, as will be described below. Thus, a second embodiment will now be described with reference to FIGS. 1 and 9B. A fourth embodiment can apply gate array methods to hierarchy blocks.

The fourth embodiment will now be described with more detail with reference to FIG. 1. In a similar fashion as the above embodiments, a circuit inputting unit 11 can input configuration data for a integrated circuit, such as a net list, or the like. Next, a hierarchy block producing unit 12, on the basis of a relationship of connections between logic hierarchies, can divide logic hierarchies into a number of hierarchy blocks, which can form layout objects. Next, a hierarchy block shape determining unit 13 can determine a shape for hierarchy blocks, so that a height for such hierarchy blocks can be essentially equal.

Next, a row producing unit 14 can produce rows in which hierarchy blocks having a same sizes are to be arranged in a top hierarchy. A hierarchy block automatically arranging unit 15 can then arrange hierarchy blocks into rows of a top hierarchy. Such an arranging of hierarchy blocks may occur in the same general fashion as the embodiment described above. Next, an external terminal position determining unit 16 can determine positions of external terminals for hierarchy blocks. A top hierarchy wiring unit 17 can then distribute wiring between external terminal positions of hierarchy blocks as established by an external terminal position determining unit 16, and such a wiring method may use conventional approaches, like those described above. FIG. 8 is one very particular example of wiring results for a top hierarchy.

Subsequently, a hierarchy block arrangement and wiring unit 18 can carry out arranging and wiring within hierarchy blocks. In a fourth embodiment, such arrangement and wiring can be according to gate array methods. Thus, rows within hierarchy blocks may be produced before an arrangement of the hierarchy blocks. Methods for producing such rows can be conventional gate array methods.

FIG. 9B is an example of layout results for hierarchy blocks using a gate array method. Because such arrangement and wiring for hierarchical block may be carried out independently of one another, it can be possible to process the arrangement of wiring for each hierarchy block in parallel with one another. An arrangement and wiring method for individual hierarchy blocks can be conventional, like those described above.

Finally, assuming that an area and timing judging unit 19 does not find any problems with the area and timing of a resulting semiconductor integrated circuit design, an arrangement and wiring result merging unit 20 can merge the results of a top hierarchy layout with that of hierarchy blocks to produce flat layout result.

As has been described above, according to a fourth embodiment, even though a large scale integrated circuit device is divided into a number of hierarchy blocks, arrangement and wiring for hierarchy blocks may be carried out independently according to a gate array method. This can make it possible to optimize timing, not for a whole semiconductor integrated circuit, but in a partial portion, such as a hierarchy block. Such an approach can enhance timing convergence and/or reduce the area of a hierarchy block. Further, as in the case of the third embodiment, in a fourth embodiment wiring for hierarchy blocks can be handled in a similar fashion to standard cell methods, and thus it may also be possible to remove variations in the congestion of wiring areas (channels) that may result from conventional hierarchy block arranging methods, where results may depend upon the experience and skill of a designer.

As set forth in the above embodiments, according to the present invention, a large scale integrated circuit device may be divided into a number of hierarchy blocks, and a layout process for connections between such hierarchy blocks can be performed independently. Such an approach can enable the layout of a large scale integrated circuit device to be performed, and can enable turnaround times (TAT) for a layout process to be reduced.

In addition, an approach of the present invention may enable timing to be optimized, not for a whole semiconductor integrated circuit, but in a partial portion, such as for hierarchy blocks or connections between such hierarchy blocks. In this way, timing convergence can be enhanced and/or the area of a semiconductor device reduced.

Furthermore, according to various embodiments, hierarchy blocks can be formed by dividing logical hierarchies of an integrated circuit. Such hierarchy block can have an essentially uniform height. Thus, because hierarchy blocks can have such a uniform shape, such hierarchy blocks can be arranged and wired according to standard cell methods. As a result, it is possible to carry out layout for hierarchy blocks on the basis of conventional, automatic arrangement and wiring methods. In addition, in embodiments that form hierarchy blocks with a same number of external terminals, wiring areas (channels) of a top hierarchy can be formed that are substantially uniform. This can simplify estimation of wiring areas (channels) in an integrated circuit design.

From the foregoing it can be understood that the occurrence of excesses and/or deficiencies of wiring within wiring areas (channels) can be greatly reduced or eliminated. In particular, it can be possible to remove wiring detours arising from insufficient wiring area, and to remove variations in the congestion of wiring areas (channels) that may result from conventional hierarchy block arranging methods, where results may depend upon the experience and skill of a designer.

In other words, the present invention can provide the following effects:

First, it can be possible to reduce a turnaround time (TAT) of a layout processing. Such an effect can result from a large scale integrated circuit being divided into a number of hierarchy blocks of essentially equal height, and rows for such hierarchy blocks being produced for a top hierarchy. Thus, arrangement and wiring for hierarchy blocks can be carried out in an automatic fashion, similar to a standard cell method, and arrangement and wiring for individual hierarchy blocks may be performed in parallel.

A second effect can be reduction in the area of a semiconductor integrated circuit. Such an effect can result from producing hierarchy blocks with essentially uniform numbers of external terminals and essentially equal height. This can produce a uniform relationship for connections between external terminals, where such connections are carried out as wiring in wiring areas (channels). It can thus be relatively each to estimate wiring areas (channels) for a top hierarchy. Further, such a wiring for a top hierarchy can be carried out in a similar fashion as standard cell methods. Because external connections and wiring thereto are established, excesses and/or deficiencies of wiring within wiring areas (channels) can be greatly reduced or eliminated that would otherwise arise in conventional hierarchy block arranging methods, where results may depend upon the experience and skill of a designer.

A reduction in area can also result from the production of hierarchy blocks that have an essentially uniform number of logic circuits, and thus can have an essentially equal height and width. Such same hierarchy block shapes can allow wiring areas (channels) for a top hierarchy to extend in vertical and horizontal directions, which can lead to shorter wiring paths for a top hierarchy. Further, the occurrence of wiring detours of congested areas may be reduced or essentially eliminated, thereby avoiding excesses and/or deficiencies of wiring within wiring areas (channels) that may result from conventional hierarchy block arranging methods, where such results may depend upon the experience and skill of a designer.

A third effect can be the essential removal of variation in congestion of wiring areas (channels) that can result from conventional hierarchy block arranging methods that depend upon the experience and skill of a designer. Such an effect can be realized by producing hierarchy blocks in which a number of external terminals and a height can be essentially uniform. Thus, it can be easier to estimate wiring areas (channels) for a top hierarchy. Further, automatic arrangement and wiring can be carried out for hierarchy blocks in a similar fashion to standard cell methods. This can allow for shorter wiring paths in a top hierarchy and thus reduce or eliminate the occurrence of excesses and/or deficiencies of wiring areas (channels). In this way, the use of wiring detours for bypassing congested wiring areas can be avoided, and hence the extra area needed for such wiring detours is not necessary.

Another reason for the third effect is that when hierarchy blocks are produced, a number of logic circuits and a height for each hierarchy blocks can be essentially uniform. This can result in hierarchy blocks having essentially the same width. Wiring areas (channels) may thus be formed not only in a horizontal direction, but also in a vertical direction. This can avoid excesses and/or deficiencies of wiring within wiring areas (channels), thus avoiding the use of wiring detours for bypassing congested wiring areas.

A fourth effect can be easier estimation of wiring areas (channels) for a top hierarchy: Such an effect can be realized because when hierarchy blocks are produced, a number of external terminals and a height of such hierarchy blocks can be essentially uniform. Thus, it can be easier to estimate wiring areas (channels) for a top hierarchy.

A fifth h effect can be enhanced timing convergence for hierarchy blocks. Such an effect can be realized because an arrangement and wiring for hierarchy blocks can be carried out independently, thus enabling timing to be optimized, not for an entire semiconductor integrated circuit, but for a partial section, such as for connections between hierarchy blocks.

A sixth effect can be reductions in the area of hierarchy blocks. Such an effect can be realized because arrangement and wiring for hierarchy blocks can be carried out independently, thus enabling a layout to be optimized, not for an entire semiconductor integrated circuit, but for a partial section, such as the hierarchy blocks.

A seventh effect can be the ability to layout a large scale semiconductor integrated circuits. Such an effect can be realized because a large scale semiconductor integrated circuit can be divided into a number of hierarchy blocks, and layout processing may be performed independently and concurrently for such hierarchy blocks according to conventional standard cell and/or gate array methods.

While various particular embodiments set forth herein have been described in detail, the present invention could be subject to various changes, substitutions, and alterations without departing from the spirit and scope of the invention. Accordingly, the present invention is intended to be limited only as defined by the appended claims.

What is claimed is:

1. An automatic arrangement and wiring method for the layout design of a semiconductor integrated circuit, comprising the steps of:
dividing the semiconductor integrated circuit design into a plurality of hierarchy blocks, each having essentially the same height;
forming rows for a top hierarchy of a semiconductor integrated circuit, each row having essentially the same height as the hierarchy blocks; and
generating a layout design for the top hierarchy and the hierarchy blocks independently of one another.

2. The automatic arrangement and wiring method of claim 1, wherein:
wiring between hierarchy blocks occurs at external terminals of the hierarchy blocks; and
the step of dividing the semiconductor integrated circuit design into a plurality of hierarchy blocks includes forming hierarchy blocks with essentially the same number of external terminals.

3. The automatic arrangement and wiring method of claim 1, wherein:
each hierarchy includes a plurality of logic circuits; and
the step of dividing the semiconductor integrated circuit design into a plurality of hierarchy blocks includes forming hierarchy blocks with essentially the same number of logic circuits.

4. The automatic arrangement and wiring method of claim 1, wherein:
the hierarchy blocks are automatically arranged in the rows of the top hierarchy.

5. The automatic arrangement and wiring method of claim 1, wherein:
wiring between hierarchy blocks occurs at external terminals of the hierarchy blocks; and
after the hierarchy blocks are automatically arranged in the rows of the top hierarchy, positions of external terminals are determined based on connections between hierarchy blocks.

6. The automatic arrangement and wiring method of claim 1, further including:
merging the layout designs of the top hierarchy and the hierarchy blocks to form a single wiring layer for the semiconductor integrated circuit.

7. The automatic arrangement and wiring method of claim 1, wherein:
the step of generating a layout design for the hierarchy blocks includes forming a layout design with a method selected from the group consisting of the standard cell method and the gate array method.

8. An automatic arrangement and wiring apparatus, comprising:
a hierarchy block shape determining unit for determining shapes for hierarchy blocks formed by dividing a semiconductor integrated circuit according to logical groups, the hierarchy block shapes having an essentially equal height;
a hierarchy block automatically arranging unit for automatically arranging the hierarchy blocks in a plurality of rows for a top hierarchy;
an external terminal positioning determining unit for determining positions of external terminals for the hierarchy blocks based on the relationship of connections between the hierarchy blocks; and
a top hierarchy wiring unit for distributing a top hierarchy wiring between external terminals of the hierarchy blocks independently of the layout and wiring of the individual hierarchy blocks.

9. The automatic arrangement and wiring apparatus of claim 8, further including:
a hierarchy block producing unit for dividing net list data for the semiconductor integrated circuit to form the hierarchy blocks.

10. The automatic arrangement and wiring apparatus of claim 8, further including:
a row producing unit for producing the rows for the top hierarchy of the semiconductor integrated circuit.

11. The automatic arrangement and wiring apparatus of claim 8, further including:
a hierarchy block arrangement and wiring unit for carrying out arrangement and wiring for each hierarchy block independently of the top hierarchy wiring.

12. The automatic arrangement and wiring apparatus of claim 8, further including:
an area and timing judging unit for judging areas and timing with respect to the top hierarchy wiring and a wiring for the hierarchy blocks.

13. The automatic arrangement and wiring apparatus of claim 8, further including:
an arrangement and wiring result merging unit for merging the arrangement and wiring of the top hierarchy with that of the hierarchy blocks to produce a single layout result.

14. A computer program embodied on computer-readable medium executable on a computing system for the layout design of a semiconductor integrated circuit, comprising:
a hierarchy block shaping unit for modifying hierarchy block data structures produced by dividing logic hierarchies of a semiconductor integrated circuit, to form hierarchy block layout forms of essentially equal height;
a row producing unit for producing layout rows for a top hierarchy of the semiconductor integrated circuit;
a hierarchy block automatically arranging unit for automatically arranging the hierarchy block layout forms in the rows;
a top hierarchy wiring unit for forming top hierarchy wiring layout form between external terminals positions of the hierarchy blocks; and
a hierarchy block arrangement and wiring unit for arranging and wiring structures for each hierarchy block layout form independently of the top hierarchy wiring layout form.

15. The computer program of claim 14, further including:
a hierarchy block producing unit for dividing integrated circuit design data to produce the plurality of hierarchy block data structures.

16. The computer program of claim 15, wherein:
the hierarchy block structures are connected to one another by external terminals; and
the hierarchy block producing unit divides the integrated circuit design data to produce hierarchy block data structures having essentially equal numbers of external terminals.

17. The computer program of claim 15, wherein:
the hierarchy block producing unit divides the integrated circuit design data to produce hierarchy block data structures having essentially equal numbers of logic circuits.

18. The computer program of claim 14, further including:
an external terminal position determining unit for determining the external terminal positions based on connection relationships between the hierarchy blocks.

19. The computer program of claim 14, further including:
an area and timing unit for judging areas and timing with respect to a top hierarchy having the top hierarchy wiring layout form and the hierarchy block layout forms as arranged and wired by the hierarchy block arrangement and wiring unit.

20. The computer program of claim 19, further including:
an arrangement and wiring result merging unit for merging the top hierarchy wiring layout form and hierarchy block layout forms as arranged and wired by the hierarchy block arrangement and wiring unit in response to a judgment result from the area and timing unit.
